(19) United States
(12) Patent Application Publication
(10) Pub. No.: US 2005/0225284 A1
(43) Pub. Date: Oct. 13, 2005

(54) Back-up battery compartment

(76) Inventor: William H. Pangburn, New Palestine, IN (US)

Correspondence Address: Woodard, Emhardt, Moriarty, McNett & Henry LLP;Bank One Center/Tower, 111 Monument Circle, Suite 3700, Indianapolis, IN, 46204-5137, US

(21) Appl. No.: 10/821,776

(22) Filed: Apr. 9, 2004

(51) Int. Cl. H01M 2/00

(52) U.S. Cl. 320/110

(57) ABSTRACT

Electronic device having a back-up battery compartment is described. The back-up battery compartment is capable of holding a battery having sufficient power to power the electronic circuitry present in the device. The back-up battery may be connected to the electronic circuitry within the electronic device via an electronic or manual switch.

### TECHNICAL FIELD

The present invention relates to electronic devices, particularly to a back-up battery compartment for electronic devices.

### BACKGROUND

Many electronic devices today run on battery power. Battery powered devices are easily portable and may be carried with the user while the user is traveling. Certain devices have a critical need for back-up power sources. For example, a global positioning system (GPS) that operates using battery power is extremely useful to a hiker or other outdoorsmen, and the failure of such a device due to batteries becoming drained could jeopardize the safety of the user. If such a traveler has forgotten to bring a spare set of batteries or they have been ruined by the elements, then the battery-powered device cannot be made operational once more. Therefore, the need exists to provide a device having the ability to provide back-up power.

### SUMMARY

The invention is described wholly in the claims and this section is not intended to expand or limit the scope of protection described by the claims. In one form of the invention, a device having electronic circuitry powered by at least one powering battery is described. The device has a first compartment formed within the housing wherein at least one powering battery is contained within the first compartment. The device also includes a second compartment formed within the housing and at least one spare battery is contained within the second compartment. The electronic circuitry is not powered by the spare battery when the spare battery is contained within the second compartment.

### BRIEF DESCRIPTION OF THE DRAWINGS

FIG. 1 is a schematic drawing of one embodiment of the present invention.

FIG. 2 is a schematic drawing of an alternative embodiment of the present invention.

### DETAILED DESCRIPTION OF SELECTED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

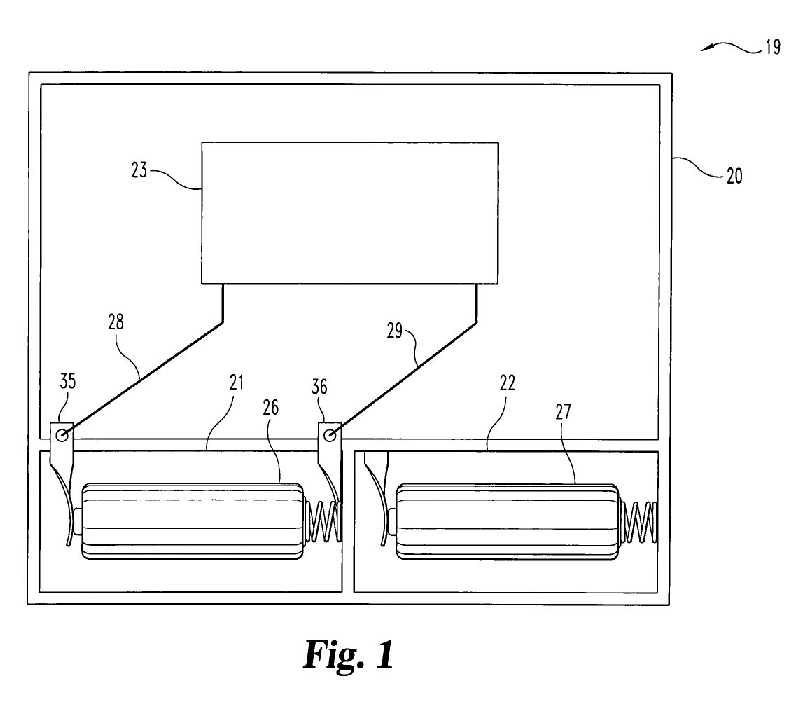

Referring now to FIG. 1, one embodiment of the present invention is described. Electronic device 19 includes a housing 20. Formed within housing 20 are a first compartment 21 and a second compartment 22. The device 19 also includes electronic circuitry 23 within the housing 20. First compartment 21 includes a first battery 26 which provides power to the electronic circuitry 23. First battery 26 is contacted by a first battery terminal 35 and a second battery terminal 36. The second compartment 22 is designed to hold a second, spare battery 27 which is not used to power the electronic circuitry 23 while the spare battery 27 is in the second compartment 22. The second compartment 22 is provided simply for storage of the spare battery 27. The first battery 26 is electronically connected to electronic circuitry 23 via first lead wire 28 coupled to the battery terminal 35 and a second lead wire 29 coupled to the battery terminal 36. This configuration allows battery 26 to provide power to electronic circuitry 23 in order to operate electronic device 19.

In use, the powering battery 26 may be removed from the first compartment 21 when desired, such as when it no longer contains enough power to operate the electronic circuitry 23. Spare battery 27 may then be removed from the second compartment 22 and placed into the first compartment 21. Spare battery 27 will thereafter provide power to the electronic circuitry 23 through the lead wires 28, 29.

It will be appreciated that while the various embodiments of the present invention are illustrated with a single powering battery and a single backup battery, the present invention comprehends that any number of powering and backup batteries may be contained within the compartments 21 and 22 as desired. Any type of battery may be used, including AAA, AA, C, D and smaller batteries used for powering smaller pieces of electronic equipment. Furthermore, rechargeable batteries may be used.

It will be appreciated by those skilled in the art that the provision for storage of the backup battery 27 in the second compartment 22 provides confidence to the user of the device 19 that a backup battery is always present in case of failure of the main battery 26. Furthermore, placement of second battery 27 into second compartment 22 protects the battery 27 from the elements and minimizes the chance for loss of the spare battery 27.

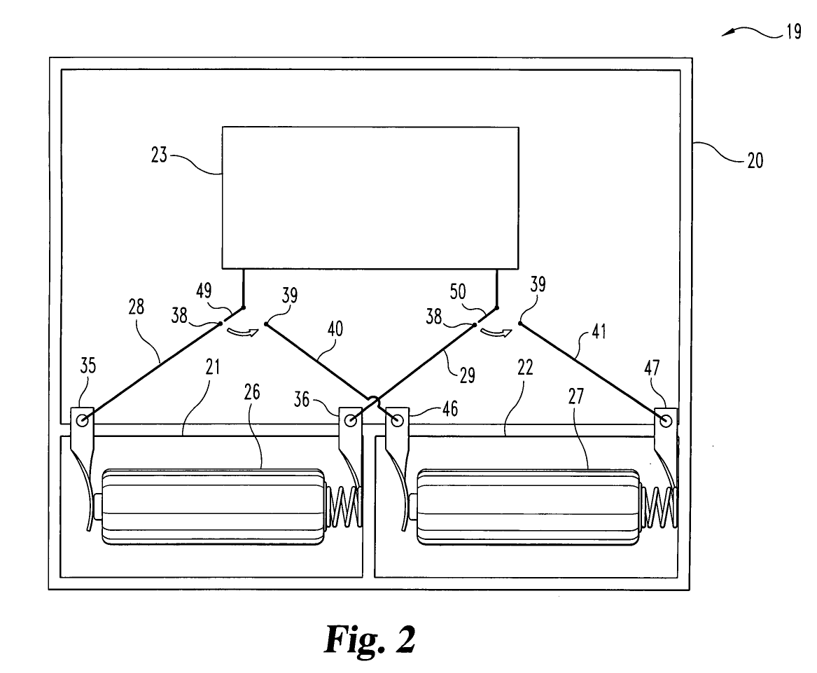

Referring now to FIG. 2, an alternative embodiment of the present invention is disclosed. This embodiment is substantially identical to the embodiment described in FIG. 1, except an electronic switching apparatus has been added. A first switch 49 and a second switch 50 (or a single double throw switch) transfers the connection of lead wires 28 and 29 between the different connecting wires to the batteries. Switch 49 and switch 50 transfer the connection from junction pair 38 to junction pair 39. Switch 49 and switch 50 transfer the electrical connection from first lead wire 28 and second lead wire 29 of first compartment 21 to connecting wire 40 and second connecting wire 41 of second compartment 22. Second compartment 22 includes a positive terminal 46 and a negative terminal 47. Positive terminal 46 and negative terminal 47 connect to connecting wire 40 and second connecting wire 41, respectively.

By providing the switch 49/50, power to the electronic circuitry 23 may be switched from first battery 26 to second battery 27 without the need to remove the batteries from their respective compartments. The switching may be performed through a variety of manners, including, but not limited to an automatic electronic switch (activated by sensing a loss of power from battery 26), a physical switch located on the exterior of the housing 20, some combination of both, or any other method of switching electronic circuitry known to one skilled in the art.

All publications and patent applications cited in this specification are herein incorporated by reference as if each individual publication or patent application were specifically and individually indicated to be incorporated by reference. Further, any theory, mechanism of operation, proof, or finding stated herein is meant to further enhance understanding of the present invention, and is not intended to limit the present invention in any way to such theory, mechanism of operation, proof, or finding. While the invention has been illustrated and described in detail in the drawings and foregoing description, the same is to be considered as illustrative and not restrictive in character, it being understood that only selected embodiments have been shown and described and that all equivalents, changes, and modifications that come within the spirit of the inventions as defined herein or by the following claims are desired to be protected.

1. A device having electronic circuitry powered by at least one battery, the
device comprising:
a housing;
a first compartment formed within said housing;
at least one first battery contained within said first compartment;
a second compartment formed within said housing; and
at least one second battery contained within said second compartment, wherein said electronic circuitry is not powered by one of said first battery and said second battery at any point in time.

2. The device as described in claim 1 further including a switch, wherein said switch may be activated to operatively couple either said first or second battery to said electronic circuitry.

3. The device as described in claim 2 wherein said activation occurs automatically.

4. The device of claim 3, wherein said automatic activation occurs when a power of one of said first and second batteries falls below a predetermined threshold.

5. The device as described in claim 2 wherein said switch is activated manually.

6. A device having electronic circuitry powered by at least one battery, the
device comprising:
a housing;
a first compartment formed within said housing;
at least one first battery contained within said first compartment;
a second compartment formed within said housing;
at least one second battery contained within said second compartment, wherein said electronic circuitry is not powered by one of said first battery and said second battery at any point in time; and
a switch, wherein said switch may be activated to operatively couple either said first or second battery to said electronic circuitry.

7. The device as described in claim 6 wherein said activation occurs automatically.

8. The device of claim 6, wherein said automatic activation occurs when a power of one of said first and second batteries falls below a predetermined threshold.

9. The device as described in claim 6 wherein said switch is activated manually.

10. A device having electronic circuitry powered by at least one powering battery,
the device comprising:
a housing;
a first compartment formed within said housing, wherein said at least one powering battery is contained within said first compartment;
a second compartment formed within said housing; and
at least one spare battery contained within said second compartment, wherein said electronic circuitry is not powered by said spare battery when said spare battery is contained within said second compartment.
